(19) United States
(12) Patent Application Publication
(10) Pub. No.: US 2018/0311928 A1
(43) Pub. Date: Nov. 1, 2018

(54) ADHESIVE TAPE FOR SPLICING OF METAL SHEETS USED IN HIGH-TENSION, HIGH TEMPERATURE PROCESSES

(71) Applicant: tesa SE, Norderstedt (DE)

(72) Inventor: Derek Edward TWORK, Caledonia, MI (US)

(21) Appl. No.: 15/499,682

(22) Filed: Apr. 27, 2017

(51) Int. Cl. B32B 5/02; B32B 7/12; B32B 37/06; B32B 37/12; C09J 5/00; C09J 7/02; C09J 7/04

(52) U.S. Cl. CPC B32B 5/024; B32B 7/12; B32B 37/06; B32B 37/12; C09J 5/00; C09J 7/0285; C09J 2400/263; C09J 7/04; B32B 2405/00; B32B 2309/105; C09J 2467/006; C09J 2477/006; C09J 7/0282

(57) ABSTRACT

Provided are adhesive tapes for splicing metal materials and methods of splicing and processing the metal materials. The adhesive tape provides an end-to-end splice of metal sheets. An example adhesive tape comprises a first adhesive layer, a second adhesive layer, a carrier positioned between the first adhesive layer and the second adhesive layer, a backing comprising a material selected from the group consisting of woven polyester, polyester film, polyamide film, and any combination thereof; wherein the backing is positioned adjacent to the second adhesive layer, and a liner adjacent to and covering at least a portion of the first adhesive layer.

### TECHNICAL FIELD

The present disclosure relates to adhesive tapes used for splicing coils of metal sheets, and more particularly, to the splicing of metal sheets with an adhesive tape that withstands the high-tension, high temperature processing of the metal sheets.

### BACKGROUND

The splicing of metal sheets may be of particular importance to the architectural and construction industries. These metal sheets may be used for paneling or other building materials and may even be colored to produce specific designs on the exteriors of structures. Typically, coils of the metal sheets are processed into panels or other such building materials under high-tension and high temperature material processing applications. The coils may be spliced together using a variety of mechanical means such as rivets or physical processes such as crimping. The spliced sections are removed and scrapped after the metal sheets have been processed into their final products. The mechanical splices may extend over large sections of the metal sheets and consequently may produce a lot of wasted material when removed. Further, the splicing means (e.g., rivets) may require an overlapping splice that wastes even more material relative to end-to-end splicing, commonly referred to as butt splicing. Typically this wasted material is only sufficient for scrap and cannot be processed into the desired building material.

Other non-mechanical methods of splicing may be deployed such as adhesives; however, these methods may fail under the high-tension and high temperature processing that the metal sheets undergo. For example, some high-tension and high temperature processing may require the adhesive to withstand temperatures greater than 400° F. for longer than seven minutes while maintaining the splice under tensile forces greater than 44 N/cm. If the splice fails under these high-tension and high temperature conditions, the material processing may be halted and more material may be wasted and scrapped.

Additionally, for some specific processing applications it may be desirable to splice varying lengths of different colored metal sheets together in a specific sequence. Some methods of mechanical splicing do not allow for the efficient splicing of varying lengths of material because the splicing is done by overlapping the two sections, which would then induce kinks in the material when coiled and cause an increase in scrap. For these methods, the processing of the metal sheets must instead be halted each time a mechanical splice is to be made so that the two lengths of metal sheets can be spliced together. This may result in increased downtime and a loss of efficiency. As such, a single coil of different lengths of colored metal sheets cannot be prepared in a single efficient process.

### SUMMARY

In an embodiment, an adhesive tape is provided. The adhesive tape provides an end-to-end splice of metal sheets. An example adhesive tape comprises a first adhesive layer, a second adhesive layer, a carrier positioned between the first adhesive layer and the second adhesive layer, a backing comprising a material selected from the group consisting of woven polyester, polyester film, polyamide film, and any combination thereof; wherein the backing is positioned adjacent to the second adhesive layer, and a liner adjacent to and covering at least a portion of the first adhesive layer.

Additionally or alternatively, the adhesive tape may include one or more of the following features individually or in combination: the first adhesive layer and the second adhesive layer may individually comprise an adhesive selected from the group consisting of an acrylic adhesive, a silicone adhesive, and a mixture thereof; the individual thickness of the first adhesive layer and the second adhesive layer may be in a range of about 75 μm to about 125 μm; if the backing comprises the woven polyester, the woven polyester may comprise a single-ply plain weave of polyethylene terephthalate fibers; the thickness of the backing may be in a range of about 160 μm to about 280 μm; the thickness of the carrier may be in a range of about 10 μm to about 16 μm.

In an embodiment, a method of providing an end-to-end splice for a metal material is provided. An example method comprises providing an adhesive tape comprising: a first adhesive layer, a second adhesive layer, a carrier positioned between the first adhesive layer and the second adhesive layer, a backing comprising a material selected from the group consisting of woven polyester, polyester film, polyamide film, and any combination thereof; wherein the backing is positioned adjacent to the second adhesive layer, and a liner adjacent to and covering at least a portion of the first adhesive layer. The method further comprises removing the liner from the adhesive tape, contacting a first length of the metal material with the first adhesive layer, and contacting a second length of the metal material with the first adhesive layer to provide a spliced material; wherein the first length and the second length are spliced end-to-end.

Additionally or alternatively, the method may include one or more of the following features individually or in combination: the spliced material may be further used in a high temperature processing application performed at a temperature of at least 300° F. for a time of at least 5 minutes; the spliced material may be further used in a high-tension processing application performed under a load of at least 30 N/cm on the spliced area for a time of at least 5 minutes; the spliced material may be used in a high temperature processing application selected from the group consisting of fusion bonding, paneling, plating, cladding, welding, cutting, and any combination thereof; the first adhesive layer and the second adhesive layer may individually comprise an adhesive selected from the group consisting of an acrylic adhesive, a silicone adhesive, and a mixture thereof; the individual thickness of the first adhesive layer and the second adhesive layer may be in a range of about 75 μm to about 125 μm; the backing may comprise a single-ply plain weave of polyethylene terephthalate fibers; the thickness of the backing may be in a range of about 160 μm to about 280 μm; the thickness of the carrier may be in a range of about 10 μm to about 16 μm.

In an embodiment, a method of processing a spliced metal material is provided. The method comprises providing a spliced metal material; wherein the spliced metal material comprises a first length and a second length spliced end-to-end with an adhesive tape. The method further comprises processing the spliced metal material in a high temperature, high-tension application performed at a temperature of at least 300° F. and under a load of at least 30 N/cm on the spliced area for a time of at least 5 minutes.

Additionally or alternatively, the method may include one or more of the following features individually or in combination: the high temperature, high-tension processing application may be performed at a temperature of at least 415° F.; the high temperature, high-tension processing application may be performed under a load of at least 44 N/cm of the spliced area; the high temperature, high-tension processing application may be fusion bonding; the metal material may be selected from the group consisting of aluminum, copper, lead, tin, zinc, copper, nickel, iron, alloys thereof, and any combination thereof.

The present disclosure and advantages associated therewith will become readily apparent in view of the detailed description provided below, including the accompanying drawings.

### BRIEF DESCRIPTION OF THE DRAWINGS

Illustrative examples of the present disclosure are described in detail below with reference to the attached drawing figures, which are incorporated by reference herein, and wherein:

FIG. 1 illustrates a cross-section of an adhesive tape in accordance with certain embodiments of the present disclosure;

FIG. 2 illustrates a cross-section of the adhesive tape illustrated in FIG. 1 adhered to a first length of a material;

FIG. 3 illustrates a cross-section of the adhesive tape illustrated in FIG. 1 used to provide an end-to-end splice of the first length of a material to a second length of the material;

FIG. 4 illustrates a cross-section of an optional embodiment in which an additional adhesive tape is adhered to the opposing side of a spliced junction of a first length and a second length of a material;

FIG. 5 illustrates an example of high temperature and high-tension testing of a spliced section of a material.

The illustrated figures are exemplary only and are not intended to assert or imply any limitation with regard to the environment, architecture, design, or process in which different examples may be implemented.

### DETAILED DESCRIPTION

The present disclosure relates to adhesive tapes used for splicing coils of metal sheets, and more particularly, to the splicing of metal sheets with an adhesive tape that withstands the high-tension, high temperature processing of the metal sheets.

Unless otherwise indicated, all numbers expressing quantities of components, properties such as temperature, force, pressure, weight, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the examples of the present invention. At the very least, and not as an attempt to limit the application of the doctrine of equivalents to the scope of the claim, each numerical parameter should at least be construed in light of the number of reported significant digits and by applying ordinary rounding techniques. It should be noted that when “about” is at the beginning of a numerical list, “about” modifies each number of the numerical list. Further, in some numerical listings of ranges some lower limits listed may be greater than some upper limits listed. One skilled in the art will recognize that the selected subset will require the selection of an upper limit in excess of the selected lower limit.

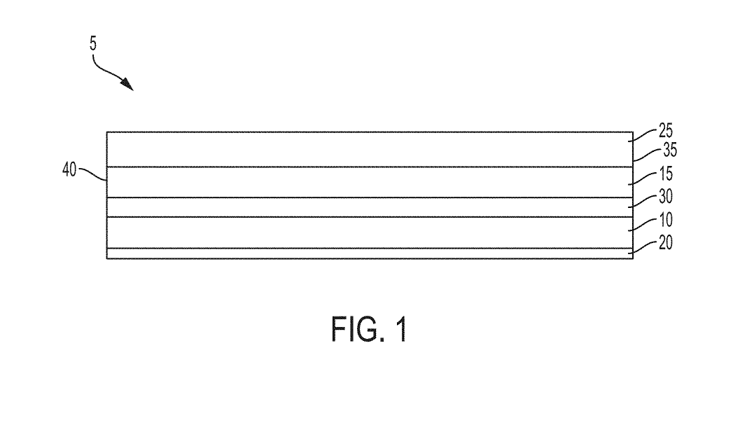

FIG. 1 illustrates a cross-section of an adhesive tape 5 in accordance with certain embodiments of the present disclosure. Adhesive tape 5 is a single-sided adhesive tape possessing two adhesive layers, first adhesive layer 10 and second adhesive layer 15. First adhesive layer 10 is an open adhesive layer that contacts the substrate (e.g. a metal sheet) when the liner 20 is removed. Second adhesive layer 15 is a closed adhesive layer that anchors the backing 25 to the remaining components of the adhesive tape 5. The carrier 30 is positioned adjacent to the first adhesive layer 10 and the second adhesive layer 15 and separates the two adhesive layers from contact with each other. The first adhesive layer 10, second adhesive layer 15, backing 25, and carrier 30 extend from a first lateral edge 35 to a second lateral edge 40. In some examples, the liner 20 may also extend from the first lateral edge 35 to the second lateral edge 40. In alternative examples, the liner 20 may not extend from the first lateral edge 35 to the second lateral edge 40. In further alternative examples, adhesive tape 5 may not comprise a liner 20.

First adhesive layer 10 and second adhesive layer 15 comprise an adhesive. The adhesive of the first adhesive layer 10 and second adhesive layer 15 may be the same or different. The adhesive of the first adhesive layer 10 and second adhesive layer 15 may be an acrylic adhesive, a silicone adhesive, or a mixture of the two. The adhesive is not a rubber-based adhesive.

The acrylic adhesive comprises polyacrylates. “Polyacrylates” are polymers whose monomer base on an amount-of-substance basis is made up to an extent of at least 30% of an acrylic acid, methacrylic acid, acrylate esters, methacrylate esters, and/or derivatives thereof. The polyacrylate may be prepared by radical polymerization of acrylic and/or methylacrylic monomers and also, optionally, further copolymerizable monomers. Examples of such monomers include, but are not limited to, n-butyl acrylate, n-butyl methacrylate, n-pentyl acrylate, n-pentyl methacrylate, n-amyl acrylate, n-hexyl acrylate, hexyl methacrylate, n-heptyl acrylate, n-octyl acrylate, n-octyl methacrylate, n-nonyl acrylate, isobutyl acrylate, isooctyl acrylate, isooctyl methacrylate, methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butyl phenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethyl-cyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxy acrylate, 3-methoxybutyl acrylate, phenoxyethyl acrylate, phenoxyethyl methacrylate, 2-phenoxyethyl methacrylate, butyldiglycol methacrylate, ethylene glycol acrylate, ethylene glycol monomethyl acrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-heptafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadecafluorooctyl methacrylate, dimethylaminopropyl-acrylamide, dimethylaminopropylmethacrylamide, N-(1-methylundecyl)acrylamide, N-(n-butoxymethyl)acrylamide, N-(butoxymethyl)methacrylamide, N-(ethoxymethyl)-acrylamide, N-(n-octadecyl)acrylamide, and also N,N-dialkyl-substituted amides, such as, for example, N, N-dimethylacrylamide, N, N-dimethylmethacrylamide, N-benzyl-acrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether, vinyl isobutyl ether, vinyl esters, such as vinyl acetate, vinyl chloride, vinyl halides, vinylidene chloride, vinylidene halides, vinylpyridine, 4-vinylpyridine, N-vinylphthalimide, N-vinyllactam, N-vinylpyrrolidone, styrene, α- and p-methyl styrene, α-butyl styrene, 4-n-butyl styrene, 4-n-decyl styrene, 3,4-dimethoxystyrene. Macromonomers such as 2-polystyreneethyl methacrylate (molecular weight Mw of 4000 to 13 000 g/mol), poly(methyl methacrylate)ethyl methacrylate (Mw of 2000 to 8000 g/mol), acrylic acid, methacrylic acid, itaconic acid, maleic acid, fumaric acid, crotonic acid, aconitic acid, dimethylacrylic acid, β-acryloyloxypropionic acid, trichloroacrylic acid, vinylacetic acid, vinylphosphonic acid, itaconic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate, glycidyl methacrylate, isomers thereof, derivatives thereof, and any combination thereof. The weight-average molecular weights of the polyacrylates are preferably in a range from 20,000 to 2,000,000 g/mol, for example, 100,000 to 1,000,000 g/mol.

Silicones are preferably polydiorganosiloxanes having a number-average molecular weight of about 5,000 to about 10,000,000 and/or copolymeric silicone resins having a number-average molecular weight of about 100 to about 1,000,000. The copolymeric silicone resins may comprise triorganosilyloxy units and also SiO_{4/2} units.

The first adhesive layer 10 and the second adhesive layer 15 may optionally comprise additives including, but not limited to, pigments, plasticizers, fillers, stabilizers, antioxidants, etc. The proportion of the additives in either of the adhesive layers may be from 0.1 to 50 wt %, based on the total weight of the respective adhesive layer.

The individual thickness of the adhesive layers 10 and 15 is in a range of about 75 μm to about 125 μm. The thickness may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the thickness may be about 75 μm, about 80 μm, about 85 μm, about 90 μm, about 95 μm, about 100 μm, about 105 μm, about 110 μm, about 115 μm, about 120 μm, or about 125 μm. With the benefit of this disclosure, one of ordinary skill in the art will be able to select a thickness for each of the adhesive layers 10 and 15 for a given application.

With continued reference to FIG. 1, the first adhesive layer 10 is lined with a liner 20. Liner 20 is optional and may not be present in some embodiments. The liner 20 may allow wider widths of the product to be dispensed with little force across the spliced area. Further, the liner 20 may protect the first adhesive layer 10 when adhesive tape 5 is provided as a roll. In some embodiments, the liner 20 may be a filmic material, for example, a monoaxially oriented polypropylene or similar material.

The backing 25 is positioned adjacent to second adhesive layer 15 on the opposing side of second adhesive layer 15 relative to the carrier 30. In embodiments, the backing 25 comprises woven polyester, polyester film, polyamide film, or any combination thereof. In a specific embodiment, the backing 25 comprises woven polyethylene terephthalate (hereafter “PET”) fibers. The backing 25 is anchored to adhesive tape 5 by the second adhesive layer 15. The backing 25 may be single-ply or multi-ply. The fabrics which make up the backing may be woven in plain-weave construction. Alternatively, some embodiments of the fabrics may be woven in satin weave or twill weave construction. The individual fibers may comprise spun yarns or filament yarns (continuous yarns). The filament yarns may be composed of a fixed number of individual filaments and may be textured or flat, with pointwise consolidation or no consolidation.

The thickness of the backing 25 is in a range of about 160 μm to about 280 μm. The thickness may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the thickness may be about 160 μm, about 170 μm, about 180 μm, about 190 μm, about 200 μm, about 210 μm, about 220 μm, about 230 μm, about 240 μm, about 250 μm, or about 260 μm. With the benefit of this disclosure, one of ordinary skill in the art will be able to select a thickness for backing 25 for a given application.

The tensile strength of the backing 25 in the warp direction is in a range of about 250 N/cm to about 330 N/cm. The tensile strength may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the tensile strength in the warp direction may be about 250 N/cm, about 260 N/cm, about 270 N/cm, about 280 N/cm, about 290 N/cm, about 300 N/cm, about 310 N/cm, about 320 N/cm, or about 330 N/cm. With the benefit of this disclosure, one of ordinary skill in the art will be able to select a backing 25 with a sufficient tensile strength in the warp direction for a given application.

The tensile strength of the backing 25 in the weft direction is in a range of about 95 N/cm to about 155 N/cm. The tensile strength may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the tensile strength in the weft direction may be about 95 N/cm, about 105 N/cm, about 115 N/cm, about 125 N/cm, about 135 N/cm, about 145 N/cm, or about 155 N/cm. With the benefit of this disclosure, one of ordinary skill in the art will be able to select a backing 25 with a sufficient tensile strength in the weft direction for a given application.

As discussed above, the second adhesive layer 15 anchors the backing 25. An amount of the adhesive of the second adhesive layer 15 may absorb into or adsorb onto the backing 25. The carrier 30 separates the first adhesive layer 10 and the second adhesive layer 15. The carrier 30 comprises a layer of PET or similar material and may be woven or nonwoven. The carrier 30 may act as an impermeable or semi-impermeable barrier to prevent the transfer and absorption of the adhesive of the first adhesive layer 10 into the second adhesive layer 15 and/or backing 25. As such, a sufficient amount of adhesive remains in the first adhesive layer 10 for contact with and splicing of the substrate.

The thickness of the carrier 30 affects the total thickness of the adhesive tape 5 and consequently may affect the individual thickness of the other components of adhesive tape 5. Generally, a thinner adhesive tape 5 is preferred for most applications. As such, providing a carrier 30 that is as thin as possible allows for the possibility of making the first adhesive layer 10 thicker by using more adhesive, which may be preferable for some applications. The thickness of the carrier 30 is in a range of about 10 μm to about 16 μm. The thickness may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the thickness may be about 10 μm, about 11 μm, about 12 μm, about 13 μm, about 14 μm, about 15 μm, or about 16 μm. With the benefit of this disclosure, one of ordinary skill in the art will be able to select a thickness for carrier 30 for a given application.

The individual components of the adhesive tape 5, for example, the first adhesive layer 10, the second adhesive layer 15, the backing 25, and the carrier 30, may be laminated together to produce the adhesive tape 5.

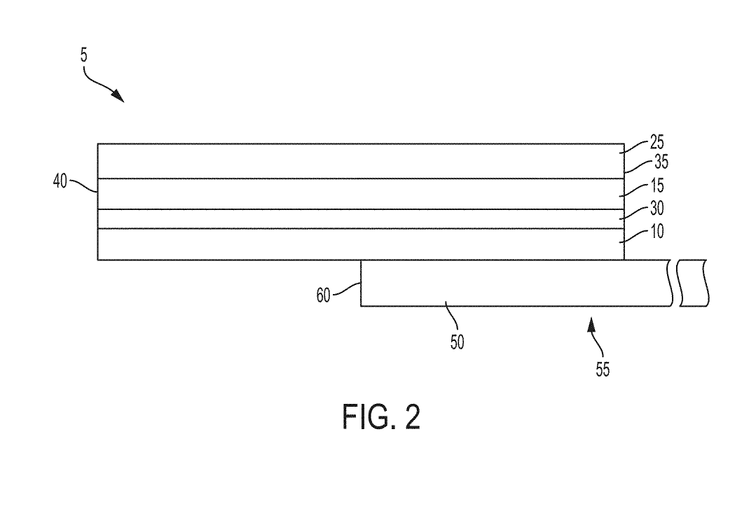

FIG. 2 illustrates a cross-section of the adhesive tape 5 illustrated in FIG. 1 adhered to a first length 50 of a material 55. As illustrated, the liner (if present) has been removed (i.e., liner 20 as illustrated in FIG. 1), and the first adhesive layer 10 is brought to a position adjacent to or proximate to the leading edge 60′ of the first length 50 of the material 55 where it then contacts the first length 50 of the material 55. The adhesive tape 5 is then adhered to the first length 50 of the material 55 by the adhesive in the first adhesive layer 10 such that it overlaps the area of the leading edge 60′ of the first length 50 of the material 55.

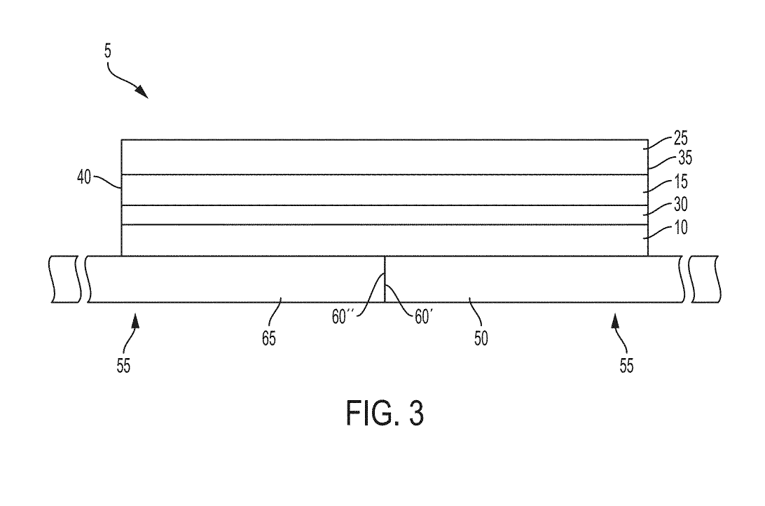

FIG. 3 illustrates a cross-section of the adhesive tape 5 illustrated in FIG. 1 used to provide an end-to-end splice (i.e., a butt splice) of the first length 50 of a material 55 to a second length 65 of the material 55. As was illustrated by FIG. 2, the adhesive tape 5 was adhered to the first length 50 of the material 55 at a position such that the first adhesive layer 10 overlapped the area of the leading edge 60′ of the first length 50 of the material 55. The portion of the first adhesive layer 10 that is still open is then brought to a position adjacent to or proximate to the leading edge 60″ of a second length 65 of the material 55 where it then contacts the second length 65 of the material 55. The adhesive tape 5 is then adhered to the second length 65 of the material 55 by the adhesive in the first adhesive layer 10 such that it splices the first length 50 to the second length 65 of the material 55 at a position where the leading edge 60′ of the first length 50 is adjacent to the leading edge 60″ of the second length 65.

As illustrated, the backing 25 is the exposed uppermost layer and provides high tensile strength, abrasion resistance, and heat stability to the splice. With the adhesive tape 5 in position, the spliced material 55 may undergo high-tension and/or high temperature processing.

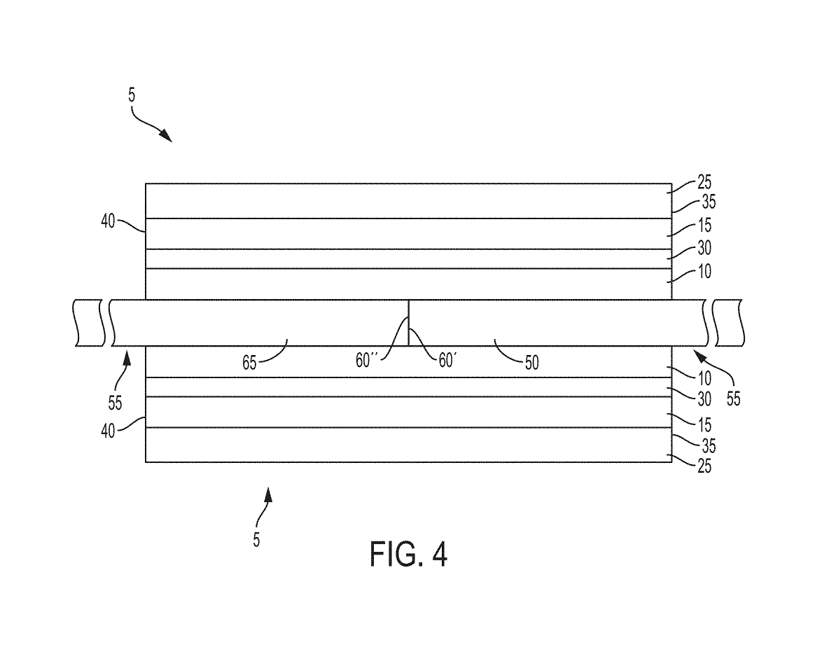

FIG. 4 illustrates an optional embodiment of the adhesive tape 5 illustrated in FIG. 1 that may be preferable for some applications. The illustration of FIG. 4 is a cross-section of an additional adhesive tape 5 adhered to the opposing side of the spliced junction of the first length 50 and the second length 65 of the material 55. After one adhesive tape 5 is used to splice a first length 50 and a second length 65 of the material 55 (e.g., as illustrated in FIG. 3), an additional adhesive tape 5 may be placed on the opposing side of the spliced junction by removing a liner (if present) and then positioning the first adhesive layer 10 adjacent to the spliced area where the leading edge 60′ of the first length 50 is adjacent the leading edge 60″ of the second length 65 of the material 55. This embodiment may provide additional stability and protection to the spliced area in some applications. The spliced material 55 may then undergo high-tension and/or high temperature processing.

With reference to all FIGUREs, the width of the splice may be any desired width and will be a function of the width of the material to be spliced. In some embodiments, the width of the spliced section may be greater than 40 inches. Optionally, in some examples, the adhesive may be cured after splicing and prior to introducing the spliced section to a high temperature and/or high-tension application. Curing the adhesive may add additional stability and may be beneficial in some applications where the spliced width is shorter, for example, less than 20 inches.

With reference to all FIGUREs, the material 55 may be any material on which the adhesive tape 5 may adhere. In some applications, the material 55 is a metal or metal alloy. For example, the material 55 may include, but is not limited to, aluminum, copper, lead, tin, zinc, copper, nickel, iron, or a combination thereof. As another example, the material 55 may include, but is not limited to, copper alloys, nickel alloys, iron alloys, aluminum alloys, or a combination thereof. If the material 55 is an alloy, the alloy may be any grade, standard, class, etc. of said alloy. The material 55 may also be a paper or filmic material. For example, the material 55 may be a thick corrugate paper product. As explained above, the adhesive tape 5 may be of particular benefit in any application where high temperature and/or high-tension end-to-end splicing is desired.

The embodiments described herein may be of particular benefit in applications where the material 55 is a coil or length of a metal sheet. In preferred embodiments, the applications are metal processing applications that process metal sheets into other materials (e.g., building materials) under high-tension and/or high temperatures. As an example, the processing may be to manufacture aluminum paneling or composite aluminum paneling from aluminum sheets. The high temperature and/or high-tension applications may include, but are not limited to, fusion bonding, paneling, plating, cladding, welding, cutting, or a combination thereof.

In embodiments, the described applications may be high temperature applications and may be performed at a temperature in a range of about 200° F. to about 700° F. For example, the process of producing aluminum paneling or composite aluminum paneling from aluminum sheets may be performed at a temperature of 415° F. The temperature may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the temperature may be about 200° F., about 250° F., about 300° F., about 350° F., about 400° F., about 450° F., about 500° F., about 550° F., about 600° F., about 650° F., or about 700° F. or greater. With the benefit of this disclosure, one of ordinary skill in the art will be able to select a temperature for a given application.

In embodiments, the described applications may be high-tension applications that apply a constant force on the spliced area in a range of about 1 N/cm to about 90 N/cm. For example, the process of producing aluminum paneling or composite aluminum paneling from aluminum sheets may apply a load on the spliced area of 44 N/cm. The force may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the force may be about 1 N/cm, about 10 N/cm, about 20 N/cm, about 30 N/cm, about 40 N/cm, about 50 N/cm, about 60 N/cm, about 70 N/cm, about 80 N/cm, or about 90 N/cm or greater. With the benefit of this disclosure, one of ordinary skill in the art will be able to select a force for a given application.

In embodiments, the described high temperature and/or high-tension applications may be performed for a time of at least 3 minutes. For example, the process of producing aluminum paneling or composite aluminum paneling from aluminum sheets may be performed at a temperature of 415° F. for a time of at least 7 minutes while under a load of 44 N/cm on the spliced area. The time may range from any lower limit to any upper limit and encompass any subset in-between. One skilled in the art will recognize that the selected subset may require the selection of an upper limit in excess of the selected lower limit. Therefore, it is to be understood that every range of values is encompassed within the broader range of values. For example, the time may be at least 3 minutes, at least 4 minutes, at least 5 minutes, at least 6 minutes, at least 7 minutes, at least 8 minutes, at least 9 minutes, at least 10 minutes, at least 15 minutes, at least 20 minutes, at least 30 minutes, or longer.

### EXAMPLES

The present disclosure can be better understood by reference to the following examples, which are offered by way of illustration. The present disclosure is not limited to the examples given herein.

### Example 1

Comparative samples of aluminum sheets were spliced and hung in an oven at 419° F. with 6 kg attached to one end to test the splice under high temperature and high-tension conditions. The adhesive tape was applied to both sides of the metal sheets prior to hanging.

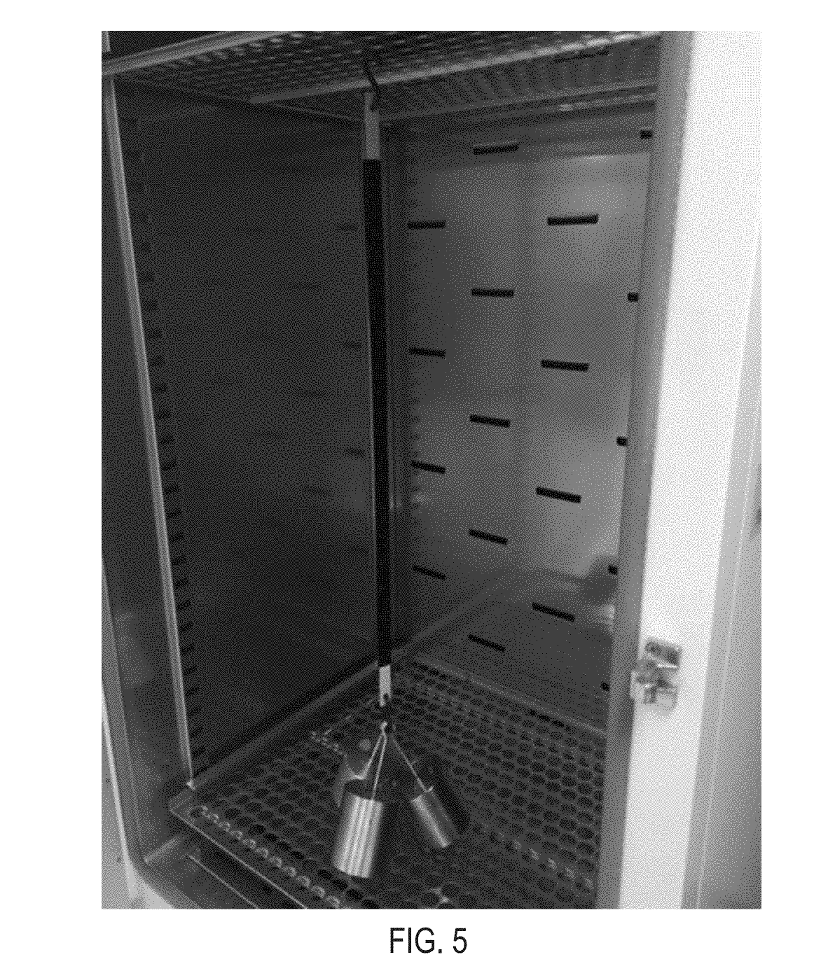

Samples of 20 inches in splice width were heat cured prior to placement in the oven. Samples of 36 inches in splice width were not heat cured prior to placement in the oven. The samples were placed in the oven for 21 minutes. Both splices held for the 21-minute interval. FIG. 5 is a picture of the 36-inch sample in the oven.

One or more illustrative examples incorporating the embodiments disclosed herein are presented. Not all features of a physical implementation are described or shown in this application for the sake of clarity. Therefore, the disclosed systems and methods are well adapted to attain the ends and advantages mentioned, as well as those that are inherent therein. The particular examples disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown other than as described in the claims below. It is therefore evident that the particular illustrative examples disclosed above may be altered, combined, or modified, and all such variations are considered within the scope of the present disclosure. The systems and methods illustratively disclosed herein may suitably be practiced in the absence of any element that is not specifically disclosed herein and/or any optional element disclosed herein.

Although the present disclosure and its advantages have been described in detail, it should be understood that various changes, substitutions and alterations may be made herein without departing from the spirit and scope of the disclosure as defined by the following claims.

What is claimed is:

1. An adhesive tape comprising:
a first adhesive layer,
a second adhesive layer,
a carrier positioned between the first adhesive layer and the second adhesive layer,
a backing comprising a material selected from the group consisting of woven polyester, polyester film, polyamide film, and any combination thereof; wherein the backing is positioned adjacent to the second adhesive layer, and
a liner adjacent to and covering at least a portion of the first adhesive layer.

2. The adhesive tape of claim 1, wherein the first adhesive layer and the second adhesive layer individually comprise an adhesive selected from the group consisting of an acrylic adhesive, a silicone adhesive, and a mixture thereof.

3. The adhesive tape of claim 1, wherein the individual thickness of the first adhesive layer and the second adhesive layer is in a range of about 75 μm to about 125 μm.

4. The adhesive tape of claim 1, wherein the backing comprises the woven polyester; wherein the woven polyester comprises a single-ply plain weave of polyethylene terephthalate fibers.

5. The adhesive tape of claim 1, wherein the thickness of the backing is in a range of about 160 μm to about 280 μm.

6. The adhesive tape of claim 1, wherein the thickness of the carrier is in a range of about 10 μm to about 16 μm.

7. A method of providing an end-to-end splice for a metal material, the method comprising:
providing an adhesive tape comprising:
a first adhesive layer,
a second adhesive layer,
a carrier positioned between the first adhesive layer and the second adhesive layer,
a backing comprising a material selected from the group consisting of woven polyester, polyester film, polyamide film, and any combination thereof; wherein the backing is positioned adjacent to the second adhesive layer, and
a liner adjacent to and covering at least a portion of the first adhesive layer;
removing the liner from the adhesive tape;
contacting a first length of the metal material with the first adhesive layer;
contacting a second length of the metal material with the first adhesive layer to provide a spliced material; wherein the first length and the second length are spliced end-to-end.

8. The method of claim 7, wherein the spliced material is further used in a high temperature processing application performed at a temperature of at least 300° F. for a time of at least 5 minutes.

9. The method of claim 7, wherein the spliced material is further used in a high-tension processing application performed under a load of at least 30 N/cm on the spliced area for a time of at least 5 minutes.

10. The method of claim 7, wherein the spliced material is used in a high temperature processing application selected from the group consisting of fusion bonding, paneling, plating, cladding, welding, cutting, and any combination thereof.

11. The method of claim 7, wherein the first adhesive layer and the second adhesive layer individually comprise an adhesive selected from the group consisting of an acrylic adhesive, a silicone adhesive, and a mixture thereof.

12. The method of claim 7, wherein the individual thickness of the first adhesive layer and the second adhesive layer is in a range of about 75 μm to about 125 μm.

13. The method of claim 7, wherein the backing comprises a single-ply plain weave of polyethylene terephthalate fibers.

14. The method of claim 7, wherein the thickness of the backing is in a range of about 160 μm to about 280 μm.

15. The method of claim 7, wherein the thickness of the carrier is in a range of about 10 μm to about 16 μm.

16. A method of processing a spliced metal material, the method comprising:
providing a spliced metal material; wherein the spliced metal material comprises a first length and a second length spliced end-to-end with an adhesive tape;
processing the spliced metal material in a high temperature, high-tension application performed at a temperature of at least 300° F. and under a load of at least 30 N/cm on the spliced area for a time of at least 5 minutes.

17. The method of claim 16, wherein the high temperature, high-tension processing application is performed at a temperature of at least 415° F.

18. The method of claim 16, wherein the high temperature, high-tension processing application is performed under a load of at least 44 N/cm of the spliced area.

19. The method of claim 16, wherein the high temperature, high-tension processing application is fusion bonding.

20. The method of claim 16, wherein the metal material is selected from the group consisting of aluminum, copper, lead, tin, zinc, copper, nickel, iron, alloys thereof, and any combination thereof.
